(19) United States
(12) Patent Application Publication
(10) Pub. No.: US 2026/0187798 A1
(43) Pub. Date: Jul. 2, 2026

(54) SYSTEM AND METHOD FOR PERFORMING TISSUE EQUALIZATION DURING IMAGE PROCESSING

(71) Applicant: GE Precision Healthcare LLC, Waukesha, WI (US)

(72) Inventors: Najib Akram Maheen Aboobacker, Waukesha, WI (US); Carlos Sabater, Wauwatosa, WI (US); Justin M. Wanek, Madison, WI (US); Ping Xue, Pewaukee, WI (US); Hongxu Yang, Helmond (NL); German Vera Gonzalez, Menomonee Falls, WI (US)

(21) Appl. No.: 19/005,898

(22) Filed: Dec. 30, 2024

(51) Int. Cl. G06T 7/00; G06T 7/11; G06T 7/136

(52) U.S. Cl. CPC G06T 7/0014; G06T 7/11; G06T 7/136; G06T 2207/10116; G06T 2207/20081; G06T 2207/30004

(57) ABSTRACT

The system comprises an X-ray system including an X-ray source, an X-ray detector positionable in alignment with the X-ray ray source, and a processing unit operably connected to the X-ray source and the X-ray detector to produce X-ray images from data transmitted from the X-ray detector. The processing unit includes a tissue equalization system configured to predict a thin tissue region and a thick tissue region based on the data transmitted from the X-ray detector and generating a predicted mask, compare the predicted mask to a true mask with a dice score, and process the data using the using the predicted mask when the dice score is above a predetermined threshold.

### FIELD OF THE DISCLOSURE

The present disclosure relates to X-ray imaging systems, and more particularly to X-ray imaging systems including ancillary image processing systems to improve workflow and the quality of images produced by the X-ray systems.

### BACKGROUND OF THE DISCLOSURE

A number of X-ray imaging systems of various designs are known and are presently in use. Such systems are generally based upon generation of X-rays that are directed from an X-ray source toward a subject of interest. The X-rays traverse the subject and impinge on a detector, for example, a film, an imaging plate, or a portable cassette. The detector detects the X-rays, which are attenuated, scattered or absorbed by the intervening structures of the subject. In medical imaging contexts, for example, such systems may be used to visualize the internal structures, tissues and organs of a subject for the purpose screening or diagnosing ailments.

With regard to the X-ray images produced by the X-ray systems, inconsistencies in image presentation of the X-ray images are a common challenge for a radiologist or other medical practitioner. The inconsistencies can be attributed to various factors such as differences in patient positioning, radiation dose, protocol selection, the presence of implants, and the like. As a result, technologists and radiologists may need to invest additional time and effort to customize, re-acquire or adjust the X-ray images. These inconsistencies are attributable to conventional tissue equalization methods that rely on fixed configurations per anatomy view and/or histogram-based display algorithms.

Therefore, it is desirable to develop a system and method for reducing inconsistencies in image presentation present in an X-ray image to reduce the time and effort required to prepare the X-ray image.

### SUMMARY OF THE DISCLOSURE

According to one aspect of an exemplary embodiment of the disclosure, an X-ray system includes an X-ray source, an X-ray detector positionable in alignment with the X-ray ray source, and a processing unit operably connected to the X-ray source and the X-ray detector to produce X-ray images from data transmitted from the X-ray detector. The processing unit includes a tissue equalization system configured to predict a thin tissue region and a thick tissue region based on the data transmitted from the X-ray detector and generating a predicted mask, compare the predicted mask to a true mask with a dice score, and process the data using the predicted mask when the dice score is above a predetermined threshold.

According to another aspect of an exemplary embodiment of the disclosure, a method of determining measurements between landmarks of an anatomy within an X-ray image includes the step of providing an X-ray system comprising an X-ray source, an X-ray detector positionable in alignment with the X-ray ray source, and a processing unit operably connected to the X-ray source and the X-ray detector to produce X-ray images from data transmitted from the X-ray detector, wherein the processing unit includes a tissue equalization system configured to predict a thin tissue region and a thick tissue region based on the data transmitted from the X-ray detector and generating a predicted mask. The method also includes the step of comparing the predicted mask to a true mask with a dice score. The method also includes the step of processing the data using the thin tissue region and the thick tissue region when the dice score is above a predetermined threshold.

These and other exemplary aspects, features and advantages of the invention will be made apparent from the following detailed description taken together with the drawing figures.

### BRIEF DESCRIPTION OF THE DRAWINGS

The drawings illustrate the best mode currently contemplated of practicing the present invention.

In the drawings:

FIG. 1 is a schematic view of an X-ray imaging system according to an exemplary embodiment of the disclosure.

FIG. 2 is a schematic view of a processor of the X-ray imaging system of FIG. 1 showing a tissue equalization system.

FIG. 3 is a flowchart of a processing operation of the tissue equalization system of FIG. 2 according to an exemplary embodiment of the disclosure.

FIG. 4 is a flowchart of a processing operation of the tissue equalization system of FIG. 2 according to an exemplary embodiment of the disclosure.

FIG. 5 is a schematic view of an output of the tissue equalization system of FIG. 2 according to an exemplary embodiment of the disclosure.

FIG. 6 is a schematic view of an area estimate of the tissue equalization system of FIG. 2 according to an exemplary embodiment of the disclosure.

FIG. 7 is a schematic view of a slider usable with the tissue equalization system of FIG. 2 according to an exemplary embodiment of the disclosure.

FIG. 8 is a schematic view of a slider graph usable with the slider of FIG. 7 according to an exemplary embodiment of the disclosure.

FIG. 9 is a flowchart of a processing operation of the tissue equalization system of FIG. 2 according to an exemplary embodiment of the disclosure.

FIG. 10A is a flowchart of a processing operation of the tissue equalization system of FIG. 2 according to an exemplary embodiment of the disclosure.

FIG. 10B is a flowchart of a processing operation of the tissue equalization system of FIG. 2 according to an exemplary embodiment of the disclosure.

### DETAILED DESCRIPTION OF THE DRAWINGS

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments. As used herein, the terms “substantially,” “generally,” and “about” indicate conditions within reasonably achievable manufacturing and assembly tolerances, relative to ideal desired conditions suitable for achieving the functional purpose of a component or assembly. Also, as used herein, “electrically coupled”, “electrically connected”, and “electrical communication” mean that the referenced elements are directly or indirectly connected such that an electrical current may flow from one to the other. The connection may include a direct conductive connection, i.e., without an intervening capacitive, inductive or active element, an inductive connection, a capacitive connection, and/or any other suitable electrical connection. Intervening components may be present. The term “real-time,” as used herein, means a level of processing responsiveness that a user senses as sufficiently immediate or that enables the processor to keep up with an external process.

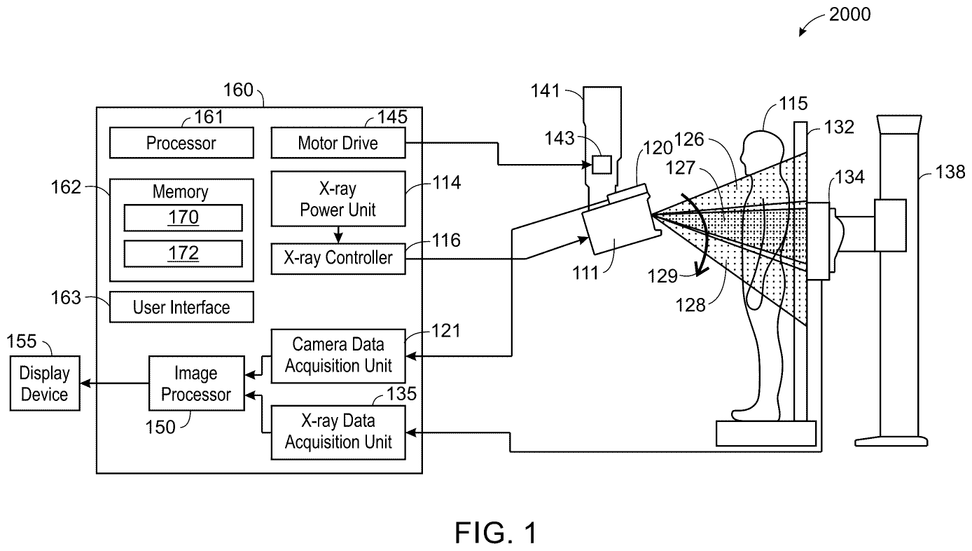

Referring to FIG. 1, a block diagram of an x-ray imaging system 2000 in accordance with an embodiment is shown. The x-ray imaging system 2000 includes an x-ray source 111 which radiates x-rays, a stand 132 upon which the subject 105 stands during an examination, and an x-ray detector 134 for detecting x-rays radiated by the x-ray source 111 and attenuated by the subject 115. The x-ray detector 134 may comprise, as non-limiting examples, a scintillator, one or more ion chamber(s), a light detector array, an x-ray exposure monitor, an electric substrate, and so on. The x-ray detector 134 is mounted on a stand 138 and is configured so as to be vertically moveable according to an imaged region of the subject.

The operation console 160 comprises a processor 161, a memory 162, a user interface 163, a motor drive 145 for controlling one or more motors 143, an x-ray power unit 114, an x-ray controller 116, a camera data acquisition unit 121, an x-ray data acquisition unit 135, and an image processor 150. X-ray image data, or a raw image, transmitted from the x-ray detector 134 is received by the x-ray data acquisition unit 135. The collected x-ray image data are image-processed by the image processor 150. A display device 155 communicatively coupled to the operating console 160 displays an image-processed x-ray image thereon.

The x-ray source 111 is supported by a support post 141 which may be mounted to a ceiling (e.g., as depicted) or mounted on a moveable stand for positioning within an imaging room. The x-ray source 111 is vertically moveable relative to the subject or patient 105. For example, one of the one or more motors 143 may be integrated into the support post 141 and may be configured to adjust a vertical position of the x-ray source 111 by increasing or decreasing the distance of the x-ray source 111 from the ceiling or floor, for example. To that end, the motor drive 145 of the operation console 160 may be communicatively coupled to the one or more motors 143 and configured to control the one or more motors 143. The one or more motors 143 may further be configured to adjust an angular position of the x-ray source 111 to change a field-of-view of the x-ray source 111, as described further herein.

The x-ray power unit 114 and the x-ray controller 116 supply power of a suitable voltage current to the x-ray source 111. A collimator (not shown) may be fixed to the x-ray source 111 for designating an irradiated field-of-view of an x-ray beam. The x-ray beam radiated from the x-ray source 111 is applied onto the subject via the collimator.

The x-ray source 111 and the camera 120 may pivot or rotate relative to the support post 141 in an angular direction 129 to image different portions of the subject 115.

Memory 162 is a suitable electronic storage medium and/or computer-readable medium that stores x-ray images 170 and executable instructions 172 that when executed cause one or more of the processor 161 and the image processor 150 to perform one or more actions.

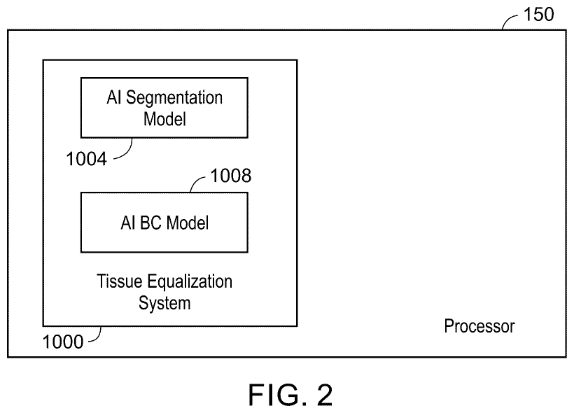

With reference to FIG. 2, the image processor 150 is configured to perform tissue equalization via a tissue equalization system 1000. Example methods that may be stored as the executable instructions 172 are described further herein with regard to the tissue equalization system 1000. Tissue equalization provides greater contrast under-penetrated, or dense, regions, and over-penetrated, or thin, regions in the processed image. In other words, tissue equalization makes thick regions in the processed image appear thinner and thin regions in the processed image appear thicker. The tissue equalization system 1000 includes an Artificial Intelligence (AI) segmentation model 1004 and an AI brightness contrast (AI BC) model 1008. The AI segmentation model 1004 may be a deep learning network configured to estimate anatomical area and tissue equalization thickness parameters of the X-ray image data. The AI BC model 1008 may be a deep learning network configured to estimate window level parameters for ideal initial display brightness contrast of the X-ray image data. The AI segmentation model 1004 and the AI BC model 1008 can also be used in conjunction with other AI algorithms (not shown) either contained on the X-ray system or employed separate from the X-ray system to perform tissue equalization.

The AI segmentation model 1004 and the AI BC model 1008 may be activated and/or deactivated via the user interface 163. However, the AI segmentation model 1004 is dependent on activation of the AI BC model 1008. In other words, the AI segmentation model 1004 cannot be activated without activation of the AI BC model 1008. This dependency is due to the AI BC model 1008 providing more consistent and ideal display parameters. Therefore, the AI BC model 1008 allows the AI segmentation model 1004 to perform more optimally. In some embodiments, the AI segmentation model 1004 and the AI BC model 1008 may be off by default. In such embodiments, the AI BC model 1008 and the AI segmentation model 1004 may discretionarily be enabled or disabled based on country specific regulatory standards, customer preference, purchase, and the like. In other embodiments, the AI segmentation model 1004 and the AI BC model 1008 may be on by default.

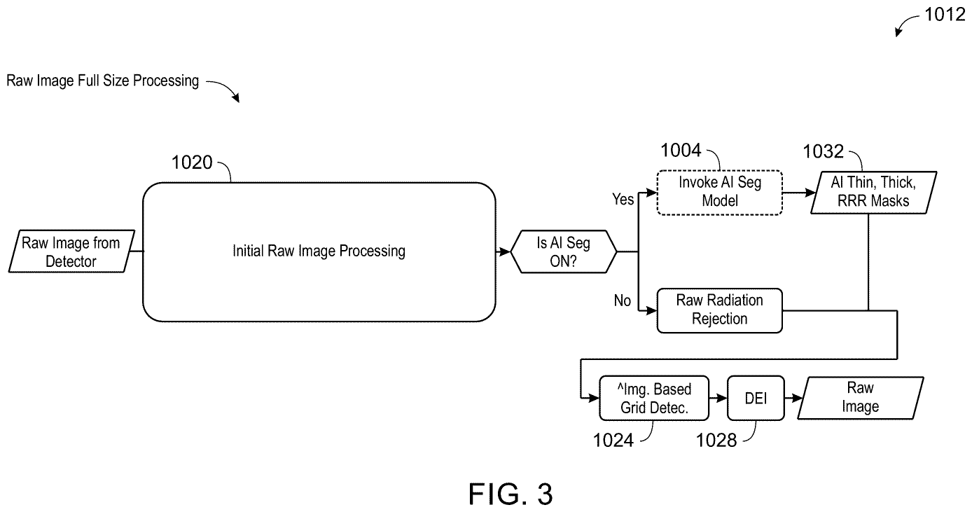

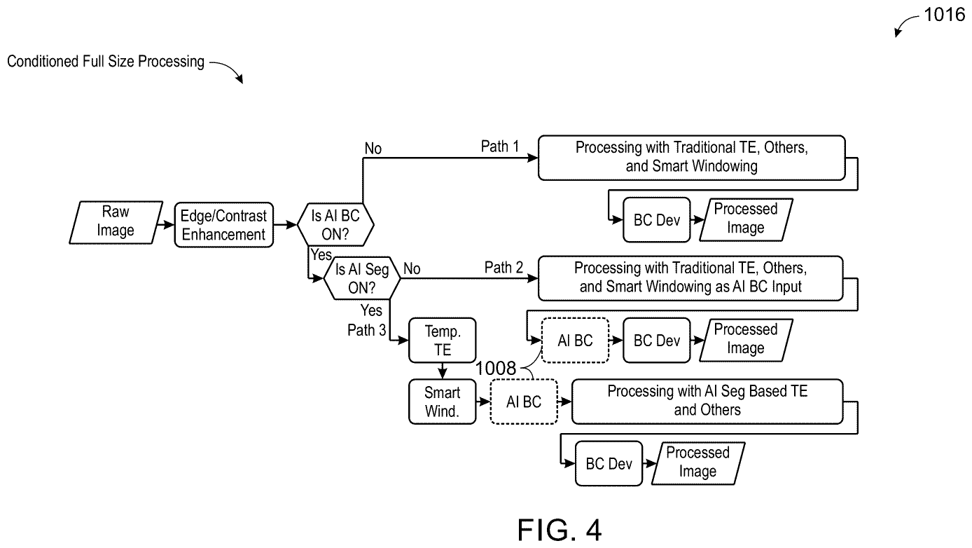

With reference to FIGS. 3 and 4, the tissue equalization system 1000 includes a raw image processing chain 1012 and a conditioned image processing chain 1016. The raw image processing chain 1012 is configured to perform initial processing of the X-ray image data to generate a raw image. The conditioned image processing chain 1016 is configured to process the raw image and output the image-processed x-ray image shown on the display device 155. Both the raw image processing chain 1012 and the conditioned image processing chain 1016 include preview image chains configured to preview the raw image without full image processing.

With continued reference to FIG. 3, the AI segmentation model 1004 is invoked in the raw image processing chain 1012. In the raw image processing chain 1012, the AI segmentation model 1004 receives as an input the raw image after the raw image has undergone initial processing 1020. For example, initial processing may include image thresholding, image area and raw radiation identification, rotation, and other raw algorithms. The raw image is provided to the AI segmentation model 1004 prior to the raw image being processed via an image-based grid detection algorithm 1024 or a DEI algorithm 1028. Therefore, a segmentation output 1032 of the AI segmentation model 1004 is not influenced by subsequent conditioned image processing elements.

With reference to FIG. 4, the AI BC model 1008 is invoked in the conditioned image processing chain 1016. The AI BC model 1008 receives as an input an image that closely resembles a displayed image on the display device 155 after image processing. Therefore, the AI BC model 1008 is situated in the conditioned image processing element after a majority of the image processing elements have been applied to the raw image. The AI segmentation model 1004 and the AI BC model 1008 are additionally included in the preview image chains.

The inputs of the AI segmentation model 1004 and the AI BC model 1008 are tailored to specific backbone network architecture on which the AI segmentation model 1004 and the AI BC model 1008 are respectively trained. Therefore, requirements of the network architecture such as size and preprocessing are required for the AI segmentation model 1004 and the AI BC model 1008 to correctly function. The AI BC model 1008 is trained on a ResNet50 architecture. The ResNet 50 architecture requires a 224 by 224 pixels image as an input. Therefore, the raw image is shuttered and resized to 224 by 224 pixels. However, prior to resizing, a Gaussian smoothing step is performed. After shuttering and smoothing, a bicubic resizing method is used to create a 224 by 224 pixel file. A display value of interest lookup table is applied to the pixel file prior to the pixel file being received as input by the AI BC model 1008. In other embodiments, the AI BC model 1008 may be trained on an alternative network architecture. In such embodiments, the AI BC model 1008 may receive an alternative input file. The AI BC model 1008 outputs a json format image.

The AI segmentation model 1004 is trained on a UNeXt multilayer perceptron backbone network architecture. The UNeXt network requires a 256 by 256 pixels image as an input. Therefore, the raw image is shrunk based on a shrink factor and is saved as a bin file in a uint16 format. In some embodiments, the shrink factor may be eight. For example, a full-size image with a pixel resolution of 0.1 may be resized to 0.125 times an original size. In other embodiments, the shrink factor may be less than eight or greater than eight. During resizing, an aspect ratio of the raw image is maintained. In other embodiments, the AI segmentation model 1004 may be trained on an alternative network architecture. In such embodiments, the AI segmentation model 1004 may receive an alternative input file. The AI segmentation model 1004 outputs three logical raw files. The raw files include a thin map, a thick map, and an anatomical map, which are saved to an inferencing package. Conversion of the logical raw maps to the raw files occurs within the inferencing package. Therefore, the logical raw maps are readily available for further processing without imposing additional complexities or post-processing tasks on the tissue equalization system 1000.

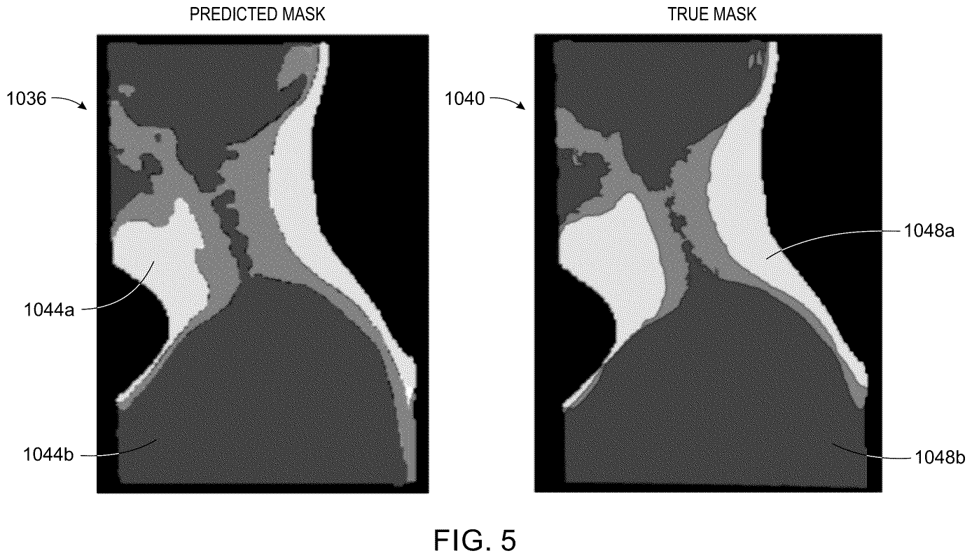

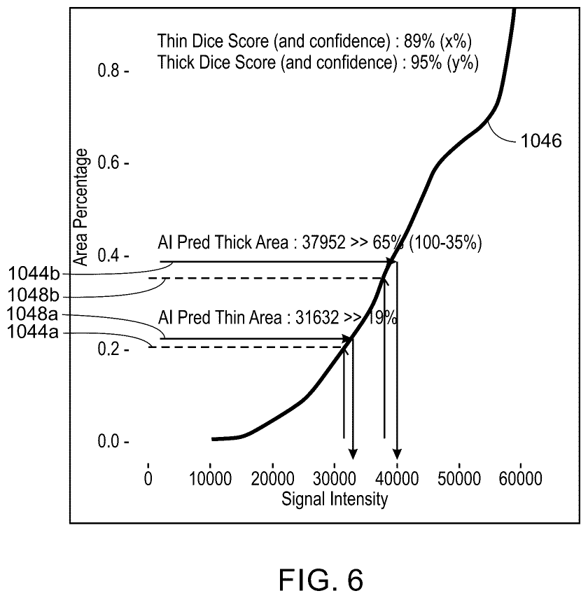

With reference to FIG. 5, the logical raw files output by the AI segmentation model 1004 may be closely aligned with trained annotations. Therefore, output masks, or predicted masks 1036 of the logical raw files are used alongside masks of cumulative histogram of thickness images, or reconstructed true masks 1040, to determine signal intensity bounds for identifying thin and thick regions 1044a, 1044b of tissue. The signal intensity bounds are used to predict respective thin and thick regions 1044a, 1044b within the output masks, creating the predicted mask 1036. For example, with reference to FIG. 6, an upper boundary of a thin region 1044a corresponds to a signal intensity of 31632, encompassing 19% of a total area in a cumulative histogram 1046. Similarly, a lower boundary of a thick region 1044b corresponds to a signal intensity of 37952, encompassing 65% of the total area in the cumulative histogram 1046. In some cases, particularly for a specific anatomic view, a predicted area of the predicted mask 1036 may not align with an ideal tissue equalization area for a factory default. In such cases, an engineering deviation may be applied. The engineering deviation represents a unique multiplicative factor configured for each anatomy view. Therefore, the AI predicted values may be scaled to align with ideal factory defaults for that specific anatomy view.

The AI segmented model predictions for the thin and thick regions 1044a, 1044b undergo a validation process prior to integration into the image processing chain. More specifically, a dice score is employed to gauge and establish similarities between the predicted masks 1036 and reconstructed true masks 1040 and outputs a number corresponding to how similar the predicted masks 1036 are to the reconstructed true masks 1040. The reconstructed true masks 1040 are created through a thresholding technique, wherein AI estimated values and the cumulative histogram 1046 of the thickness image are utilized to determine signal intensity boundaries, ultimately yielding corresponding true masks 1040. If the dice score is above a predetermined value, the thin and thick regions 1044a, 1044b produced by the AI segmented model are utilized. If the dice score falls below the predetermined value, default regions are instead utilized. This validation step prevents suboptimal area estimation, which could lead to inconsistencies in tissue equalization.

With reference to FIGS. 5 and 6, as an example, a predicted mask 1036 generated by the AI segmented model is shown. The predicted mask 1036 estimates a thin region 1044a at 19% and a thick region 1044b at 65%. A true mask 1040 is reconstructed using a thresholding technique. For example, the 19% threshold corresponds to a signal intensity of 31632, and any pixel with an intensity lower than 31632 is reconstructed as a true thin region 1048a. Similarly, any pixel with an intensity greater than 37952 is reconstructed as a true thick region 1048b. A dice score computation is performed between the predicted mask and the true mask 1040 for both the thin region 1044a and the thick region 1044b. Only if both dice scores exceed a predetermined value will the AI segmented model values be utilized for further processing. If the dice scores do not exceed the predetermined value, default tissue equalization values are employed for further processing.

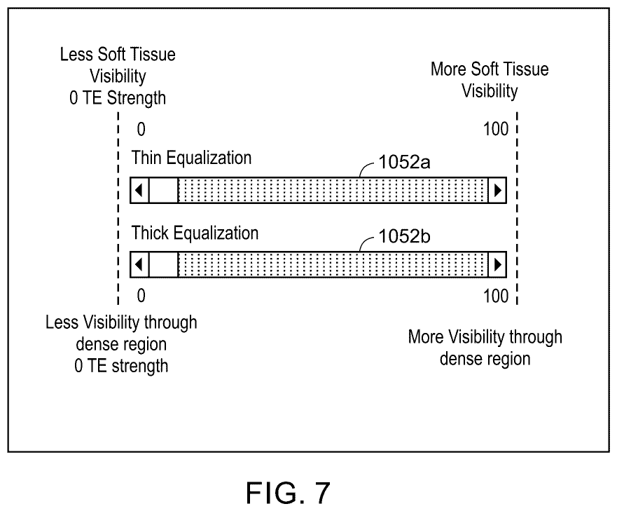

With reference to FIG. 7, in some embodiments, the user interface 163 may include a thin equalization slider 1052a and a thick equalization slider 1052b configured to increase or decrease visibility in thin tissue regions and thick tissue regions. When the AI segmentation model 1004 is enabled, the thin and thick equalization sliders 1052a, 1052b may be shown in the user interface. When the AI segmentation model 1004 is disabled, the thin and thick equalization sliders 1052a, 1052b may not be shown in the user interface 163. The thin and thick equalization sliders 1052a, 1052b function as volume dials, where higher values correspond to greater visibility of respective regions. The thin and thick equalization sliders 1052a, 1052b range from 0 to 100. The range maps to specific grayscale levels in a background. At a lower end of the range (0/100), tissue equalization strength is at 0%. Therefore, at the lower end, there is less soft tissue visibility. The lower end maps to a certain grayscale level per anatomy view. At an upper end (100/100), tissue equalization strength is at 100%. Therefore, at the upper end, there is more soft tissue visibility. The upper end delivers a specific grayscale level per anatomy view. At points in the range between 1 and 99, grayscale levels are based on a grayscale gamma curve. On average, each slider position maps to an average grayscale level per anatomy view, and a tissue equalization strength is dynamically computed to achieve average grayscale levels based on equalization slider position.

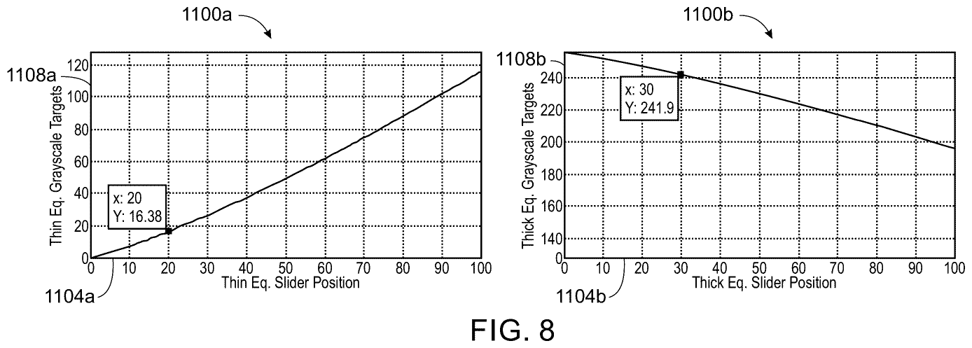

With reference to FIG. 8, as an example, a thin equalizer plot 1100a illustrates a thin equalizer position 1104a versus a thin grayscale target 1108a for image A. A thick equalizer plot 1100b illustrates a thick equalizer position 1104b versus a thick grayscale target 1108b for the image A. Here, a thin slider position of 20 maps to 16/256 grayscale for the image A and maps to approximately 18/256 for image B (not shown). Therefore, an average between image A and image B is approximately 17/256 grayscale. A final tissue equalization processed image will include thin tissue at roughly 17/256 grayscale. The same analysis is additionally computed for the thick equalizer plot.

Tissue equalization area parameters are used to determine mapping limits of the thin equalization slider and the thick equalization slider. The tissue equalization parameters are automatically adjusted to maintain maximum strength. In other words, tissue equalization area parameters dynamically adjust to consistently show maximum strength of the soft tissue. This dynamic adjustment is applicable for both the thin tissue equalization and the thick tissue equalization. Minimum and maximum mapping limits of the thin equalization slider and the thick equalization slider are determined so that a total area does not exceed 100% at any point during adjusting the mapping limits. For example, when both the thin equalization slider and the thick equalization slider are at position 100/100, maximum strength is applied to both thin and thick regions 1044a, 1044b and a total area is at 100%. Therefore, tissue equalization may be customized by the user while maintaining consistency of operation.

The thin and thick equalization sliders 1052a, 1052b maintain endpoints of 0 and 100 with increments of 1. However, a relationship between the thin and thick equalization sliders 1052a, 1052b and grayscale levels is computed for each image. First, minimum and maximum grayscale levels for both the thin region 1044a and the thick region 1044b are calculated. Next, a gamma curve is computed. The gamma curve maps the slider values to a range of grayscale levels. A gamma coefficient may be defined by a separate application. Therefore, specific grayscale levels are identified for a current position of the slider. For example, a thin equalization slider set at 20 maps to approximately 16/256 grayscale, while a thick equalization slider at position 30 maps to approximately 242/256 grayscale. Next, dynamic strength is calculated. This ensures that the processed image displays a thinnest region at a minimum of 16 grayscale and a thickest region at a maximum of 242 grayscale.

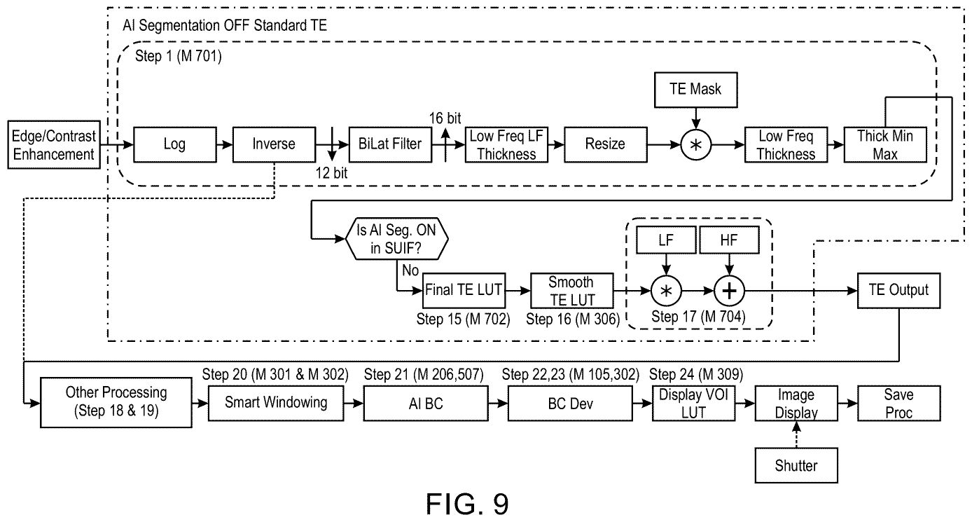

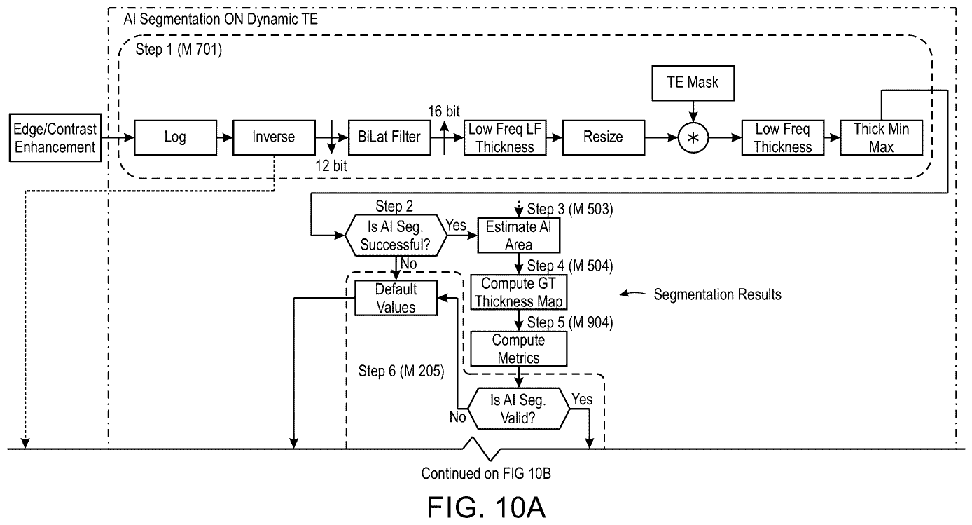

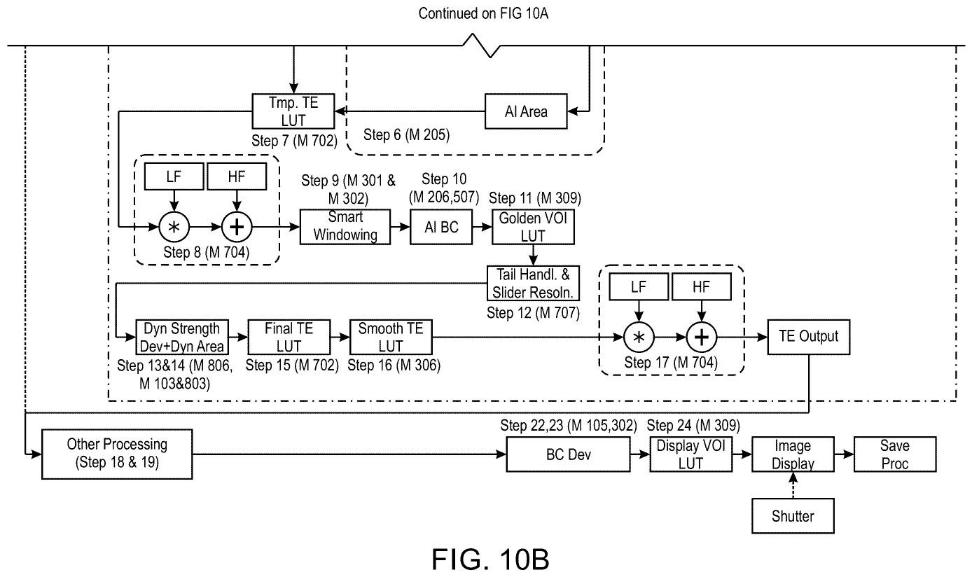

With reference to FIGS. 9 and 10, in operation, the image processor 150 takes three distinct pathways, path 1, path 2, and path 3. Path 1 is chosen when the AI segmentation model 1004 is turned off and the AI BC model 1008 is turned off. Path 2 is chosen when the AI BC model 1008 is turned on and the AI segmentation model 1004 is turned off. Path 3 is chosen when the AI segmentation model 1004 is turned on and the AI BC model 1008 is turned on. In paths 1 and 2, the AI segmentation model 1004 run status is initialized as a 0 (fail) and remains a 0 (fail) throughout the paths. Therefore, standard tissue equalization is utilized rather than dynamic tissue equalization.

With reference to FIG. 9, in paths 1 and 2, at step 1, a multi-resolution output is received from the X-ray detector. The multi-resolution output undergoes inversion via an inverse 16-bit pseudo-log transformation. To ensure compatibility with bilateral filter parameters optimized for 12-bit data, the inverted 16-bit pseudo-log image is downscaled to 12-bits. Subsequently, a bilateral filter operation is executed to derive a low-frequency thickness image, which is then upscaled back to 16-bit precision. Thereafter, an anatomical mask is applied to thickness image to identify a minimum signal intensity and a maximum signal intensity. A high-frequency image is stored in a double format to accommodate potential negative values. Since the AI segmentation model is not employed in paths 1 and 2, the image processor 160 skips to step 15. At step 15, stored tissue equalization parameters are used to calculate a final tissue equalization lookup table. At step 16, the final tissue equalization lookup table is then smoothed according to a smoothing coefficient. At step 17, the low frequency thickness image is scaled using the smoothed Final tissue equalization lookup table and added to the high-frequency image to obtain a tissue equalization output. At step 18, contrast limited adaptive histogram equalization is then performed, taking the multi-resolution output with inverse log and TE output as primary inputs. At step 20, smart windowing is then applied to calculate base and initial window levels. At step 21, the image processor 150 determines whether the AI BC model 1008 should be invoked. If the AI BC is on, the image is smoothed and resized to 224 by 224 without maintain an aspect ratio. The AI BC model 1008 is invoked iteratively with an interim value of interest lookup table applied to pixel data. Once the AI BC model 1008 iteration is completed, prefinal window levels are obtained. At steps 22 and 23, a user-adjusted BC deviation is converted to a BC adjustment equivalent range. The prefinal window levels are then scaled to obtain final window levels. At step 24, a final value of interest lookup table is created, and the processed image is displayed to the user. In other embodiments, paths 1 and 2 may include additional or alternative steps not expressly stated. Additionally, paths 1 and 2 may perform the above discussed steps in an alternative order.

With reference to FIG. 10A and B, in path 3, at step 1, a multi-resolution output is received from the X-ray detector. The multi-resolution output undergoes inversion via an inverse 16-bit pseudo-log transformation. To ensure compatibility with bilateral filter parameters optimized for 12-bit data, the inverted 16-bit pseudo-log image is downscaled to 12-bits. Subsequently, a bilateral filter operation is executed to derive a low-frequency thickness image, which is then upscaled back to 16-bit precision. Thereafter, an anatomical mask is applied to a thickness image to identify a minimum signal intensity and a maximum signal intensity. A high-frequency image is generated by subtracting the 16-bit low-frequency thickness image from the inverted 16-bit pseudo-log image. The high-frequency image is stored in a double format to accommodate potential negative values. At step 2, a check is performed to ensure that the AI segmentation model 1004 is on, and the AI segmentation model 1004 run status is pass. At step 3, the image processor 150 employs AI segmentation logical raw masks from the raw image processing chain 1012, the low-frequency thickness image, and the cumulative histogram 1046. The low-frequency thickness image pixels related to thin masks and thick masks are sorted, allowing for calculation of the thickest thin signal intensity and the thinnest thick signal intensity based on predefined percentiles. Using these calculated signal intensity bounds and the cumulative histogram 1046, respective thin and thick areas are computed. These computed areas are referred to as the predicted areas. Additionally, an engineering deviation represented as a scaling factor is applied to the predicted areas to calculate an engineering-adjusted areas.

At step 4, thickness maps are reconstructed. The AI-predicted areas, along with the cumulative histogram 1046, are employed to identify signal intensity bounds, and a thresholding approach is used to reconstruct the thin mask and the thick mask. The reconstructed masks are used to validate the AI-predicted masks 1036. At step 5, similarities between the AI output masks and the reconstructed true masks 1040 are checked using Dice scores as an evaluation metric. Dice scores are computed for both thin and thick regions 1044a, 1044b.

At step 6, an AI validity check is performed, primarily based on the Dice scores. If either the AI segmentation model 1004 run status is fail or if the Dice scores for the thin and thick regions 1044a, 1044b are not equal to or greater than a predefined cutoff value, the AI segmentation model 1004 validity status is set to fail. In such cases, pre stored default areas are used for temporary tissue equalization processing required to invoke the AI BC model 1008. If the AI segmentation model 1004 run status is pass and the Dice scores are equal to or less than the predefined cutoff value, the AI segmentation validity status is set to pass. The engineering-adjusted area is used as the temporary tissue equalization area for invoking the AI BC model 1008. At step 7, a tissue equalization look-up table is computed using the temporary tissue equalization parameters discussed above. At step 8, the low-frequency thickness image is scaled using the temporary tissue equalization lookup table previously computed. The scaled low-frequency thickness image is then combined with the high-frequency content. At step 9, histogram-based smart windowing is employed to calculate a base and initial window level for the temporary tissue equalization output. At step 10, the image processor 150 then determines whether the AI BC model 1008 should be invoked. Path 3 requires both the AI segmentation model 1004 and the AI BC model 1008 to be invoked. Therefore, the image is smoothed and resized to 224 by 224 without maintaining an aspect ratio. The AI BC is invoked iteratively with an interim value of interest lookup table applied to pixel data. Once the AI BC model 1008 iteration is completed, at step 11, prefinal window levels are obtained by scaling interim WL with the AI BC model 1008 parameters. In the case of failure of the AI BC model 1008, prefinal window levels are set back to the initial window levels. The prefinal window level parameters are employed to calculate a golden value of interest lookup table.

At step 12, a local thick minimum value and a local thick maximum value are determined. The local values are initially set to a thick minimum value and a thick maximum value. In path 3, dynamic tissue equalization strength is computed to ensure that the thin and thick regions 1044a, 1044b are displayed at specific grayscale levels when the image is visualized using the golden value of interest lookup table. In some embodiments, the histogram of an image without any tissue equalization may have a long tail, which lack significant diagnostic value. Using such points as a reference to adjust thin and thick regions 1044a, 1044b of the low frequency image to bring them within the display range might result in excessive tissue equalization strength, making the image appear flat. To address such problems, a local reference is identified using the golden value of interest lookup table and the grayscale references.

At steps 13 and 14, the minimum and maximum display grayscale levels feasible for both the thin and thick regions 1044a, 1044b areas are determined. The minimum and maximum values are mapped to the 0 and 100 positions of the thin and thick equalization sliders 1052a, 1052b. A gamma curve is computed with these values, establishing a relationship between the position of the equalization slider and grayscale range. The specific grayscale target is calculated for the current equalization slider position using the gamma curve. Dynamic areas and strengths for both the thin and thick regions 1044a, 1044b are computed so that the local thin-thick references are displayed at specific grayscale targets.

At step 15, dynamic tissue equalization parameters are used to calculate the final tissue equalization lookup table. At step 16, the Final tissue equalization lookup table is then smoothed according to a smoothing coefficient. At step 17, the low-frequency thickness image is scaled using the smoothed final tissue equalization lookup table and added to the high-frequency image to obtain a tissue equalization output. At step 18, contrast limited adaptive histogram equalization is performed, taking the multi-resolution output with the inverse log and the tissue equalization output as primary inputs. The image processor 150 skips to step 22, where user-adjusted BC deviations are then converted to a BC adjustment equivalent range. At step 23, the prefinal window levels are then scaled to obtain final window levels. At step 24, a final value of interest lookup table is then created, and the processed image is displayed to the user. In other embodiments, path 3 may include additional or alternative steps not expressly stated. Additionally, path 3 may perform the above discussed steps in an alternative order.

In other embodiments, in operation, the image processor 150 make take alternative paths. Additionally or alternatively, the paths described above may include additional or alternative steps not expressly stated.

The method includes the steps of providing an X-ray system comprising an X-ray source, an X-ray detector positionable in alignment with the X-ray ray source and a processing unit operably connected to the X-ray source and the X-ray detector to produce X-ray images from data transmitted from the X-ray detector, wherein the processing unit includes a tissue equalization system configured to predict a thin tissue region and a thick tissue region based on the data transmitted from the X-ray detector and generating a predicted mask, creating a true mask through a thresholding technique, wherein values estimated by the tissue equalization system and a cumulative histogram of a thickness image are used to determine signal boundaries, creating the true mask, comparing the predicted mask to the true mask with a dice score, and processing the data using the using the thin tissue region and the thick tissue region when the dice score is above a predetermined threshold, processing the data using default regions if the dice score is below the predetermined threshold.

Finally, it is also to be understood that the system may include the necessary computer, electronics, software, memory, storage, databases, firmware, logic/state machines, microprocessors, communication links, displays or other visual or audio user interfaces, printing devices, and any other input/output interfaces to perform the functions described herein and/or to achieve the results described herein. For example, as previously mentioned, the system may include at least one processor/processing unit/computer and system memory/data storage structures, which may include random access memory (RAM) and read-only memory (ROM). The at least one processor of the system may include one or more conventional microprocessors and one or more supplementary co-processors such as math co-processors or the like. The data storage structures discussed herein may include an appropriate combination of magnetic, optical and/or semiconductor memory, and may include, for example, RAM, ROM, flash drive, an optical disc such as a compact disc and/or a hard disk or drive.

Additionally, a software application(s)/algorithm(s) that adapts the computer/controller to perform the methods disclosed herein may be read into a main memory of the at least one processor from a computer-readable medium. The term “computer-readable medium”, as used herein, refers to any medium that (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, a RAM, a PROM, an EPROM or EEPROM (electronically erasable programmable read-only memory), a FLASH-EEPROM, any other memory chip or cartridge, or any other medium from which a computer can read.

While in embodiments, the execution of sequences of instructions in the software application causes at least one processor to perform the methods/processes described herein, hard-wired circuitry may be used in place of, or in combination with, software instructions for implementation of the methods/processes of the present invention. Therefore, embodiments of the present invention are not limited to any specific combination of hardware and/or software.

It is understood that the aforementioned compositions, apparatuses and methods of this disclosure are not limited to the particular embodiments and methodology, as these may vary. It is also understood that the terminology used herein is for the purpose of describing particular exemplary embodiments only, and is not intended to limit the scope of the present disclosure which will be limited only by the appended claims.

We claim:

1. A method of determining measurements between landmarks of an anatomy within an X-ray image comprising the steps of:
providing an X-ray system comprising:
an X-ray source;
an X-ray detector positionable in alignment with the X-ray source; and
a processing unit operably connected to the X-ray source and the X-ray detector to produce X-ray images from data transmitted from the X-ray detector, wherein the processing unit includes a tissue equalization system configured to predict a thin tissue region and a thick tissue region based on the data transmitted from the X-ray detector and generating a predicted mask;
comparing the predicted mask to a true mask with a dice score; and
processing the data using the thin tissue region and the thick tissue region when the dice score is above a predetermined threshold.

2. The method of claim 1, wherein the tissue equalization system is formed of an artificial intelligence (AI) segmentation model.

3. The method of claim 2, wherein the AI segmentation model is a deep learning network configured to estimate anatomical area and tissue equalization thickness parameters of the data.

4. The method of claim 3, wherein the tissue equalization system is also formed of an AI brightness contrast (AI BC) model.

5. The method of claim 4, wherein the AI BC model is a deep learning network configured to estimate window level parameters for ideal initial display brightness contrast of the data.

6. The method of claim 1, wherein the tissue equalization system uses output masks of the data with a cumulative histogram of a thickness image to determine signal intensity bounds for identifying the thin tissue region and the thick tissue region.

7. The method of claim 6, wherein the signal intensity bounds are used to predict the thin and thick regions within the output masks, creating the predicted mask.

8. The method of claim 1, further comprising creating the true mask through a thresholding technique, wherein values estimated by the tissue equalization system and a cumulative histogram of a thickness image are used to determine signal boundaries, creating the true mask.

9. The method of claim 8, wherein the dice score determines similarities between the true mask and the predicted mask and outputs a number corresponding to how similar the true mask is to the predicted mask.

10. The method of claim 9, wherein a dice score computation is performed between the predicted mask and the true mask for both the thin tissue region and the thick tissue region.

11. The method of claim 1, further comprising processing the data using default regions if the dice score is below the predetermined threshold.

12. The method of claim 1, wherein the X-ray system includes sliders configured to increase or decrease visibility in the thick tissue region and the thin tissue region.

13. An X-ray system comprising:
an X-ray source;
an X-ray detector positionable in alignment with the X-ray ray source; and
a processing unit operably connected to the X-ray source and the X-ray detector to produce X-ray images from data transmitted from the X-ray detector,
wherein the processing unit includes a tissue equalization system configured to predict a thin tissue region and a thick tissue region based on the data transmitted from the X-ray detector and generating a predicted mask, compare the predicted mask to a true mask with a dice score, and process the data using the predicted mask when the dice score is above a predetermined threshold.

14. The method of claim 13, wherein the tissue equalization system is formed of an artificial intelligence (AI) segmentation model, and wherein the tissue equalization system is also formed of an AI brightness contrast (AI BC) model.

15. The method of claim 14, wherein the AI segmentation model is a deep learning network configured to estimate anatomical area and tissue equalization thickness parameters of the data, and wherein the AI BC model is a deep learning network configured to estimate window level parameters for ideal initial display brightness contrast of the data.

16. The method of claim 13, wherein the tissue equalization system uses output masks of the data with a cumulative histogram of a thickness image to determine signal intensity bounds for identifying the thin tissue region and the thick tissue region.

17. The method of claim 16, wherein the signal intensity bounds are used to predict the thin and thick regions within the output masks, creating the predicted mask.

18. The method of claim 13, wherein the true mask is created through a thresholding technique, wherein values estimated by the tissue equalization system and a cumulative histogram of a thickness image are used to determine signal boundaries, creating the true mask.

19. The method of claim 18, wherein the dice score determines similarities between the true mask and the predicted mask and outputs a number corresponding to how similar the true mask is to the predicted mask.

20. The method of claim 19, wherein a dice score computation is performed between the predicted mask and the true mask for both the thin tissue region and the thick tissue region.
